(19) United States
(12) Patent Application Publication
(10) Pub. No.: US 2020/0334627 A1
(43) Pub. Date: Oct. 22, 2020

(54) SYSTEMS AND METHODS FOR SUPPLYING PRODUCTS TO AGRICULTURAL IMPLEMENTS

(71) Applicant: CNH Industrial America LLC, New Holland, PA (US)

(72) Inventors: Pinakin S. Desai, Naperville, IL (US); Peter Joseph Zerillo, Chicago, IL (US); Stephen Michael Faivre, Sycamore, IL (US); Nathan Taylor, Sycamore, IL (US); Kevin D. Monk, Shorewood, IL (US); David W. Larson, Maple Park, IL (US)

(21) Appl. No.: 16/303,865

(22) PCT Filed: May 24, 2017
(86) PCT No.: PCT/US17/34295

§ 371 Date: Nov. 21, 2018

(51) Int. Cl. G06Q 10/08

(52) U.S. Cl. CPC G06Q 10/0832; G06Q 10/087

(57) ABSTRACT

A product supply system includes a non-transitory computer-readable medium comprising instructions that when executed by a processor cause the processor to receive a first input indicative of a request to transfer a first product of the plurality of products to a first agricultural implement of the one or more of agricultural implements, to identify a first container of a plurality of containers that houses the first product, and to generate a first output that facilitates transfer of the first container to the first agricultural implement.

### CROSS-REFERENCE TO RELATED APPLICATION

This application claims priority from and the benefit of U.S. Provisional Application Ser. No. 62/340,813, entitled “SYSTEMS AND METHODS FOR SUPPLYING PRODUCTS TO AGRICULTURAL IMPLEMENTS”, filed May 24, 2016, which is hereby incorporated by reference in its entirety for all purposes.

### BACKGROUND

The present disclosure relates generally to agricultural systems and methods, and more particularly to systems and methods for supplying or delivering products to agricultural implements.

Generally, agricultural implements (e.g., planters, sprayers, harvesters, etc.) are configured to distribute agricultural product (e.g., seeds, fertilizer) across a field. The agricultural implement may improve crop yield and/or farming efficiency by increasing speed at which the product is distributed across the field and/or providing an even distribution of the product across the field. Traditional product supply systems for agricultural implements may include a specialized seed cart or a nurse tanker that resupplies a particular type of product to the agricultural implement. For example, a seed contained in a bulk storage container of a seed cart may be dispensed (e.g., via an auger) to resupply a container of a planter, while a liquid fertilizer contained in a bulk storage container of a nurse tanker may be dispensed (e.g., via tubing) to resupply a container of a sprayer. Unfortunately, the variety of equipment and methods used to resupply the agricultural implements used in the field may result in reduced farming efficiency, increased complexity, and/or increased costs.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a product supply system includes a plurality of containers. A first container of the plurality of containers houses a first product and a second container of the plurality of containers houses a second product, the first product and the second product are different types of products, and the first container and the second container are standardized containers having the same size and shape. The product supply system also includes a first agricultural implement configured to receive the first container and to use the first product and a second agricultural implement configured to receive the second container and to use the second product. The first agricultural implement and the second agricultural implement are different types of agricultural implements.

In one embodiment, a product supply system includes a non-transitory computer-readable medium comprising instructions that when executed by a processor cause the processor to receive a first input indicative of a request to transfer a first product of the plurality of products to a first agricultural implement of the one or more of agricultural implements, to identify a first container of a plurality of containers that houses the first product, and to generate a first output that facilitates transfer of the first container to the first agricultural implement.

In one embodiment, a product supply system includes a plurality of containers configured to store a plurality of different products. Each of the plurality of containers is configured to be removably mounted to one or more agricultural implements to enable the one or more agricultural implements to use the plurality of products stored within the plurality of containers. The product supply system also includes a delivery vehicle configured to support the plurality of containers and to facilitate transfer of the plurality of containers to the one or more agricultural implements

In one embodiment, a method of supplying a plurality of products to one or more agricultural implements includes receiving, at a controller, a first input indicative of a request to transfer a first product of the plurality of products to a first agricultural implement of the one or more of agricultural implements. The method includes identifying, using the controller, a first container of a plurality of containers that houses the first product. The method also includes generating, using the controller, a first output that facilitates transfer of the first container to the first agricultural implement.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of a product supply system that may be used to supply a product to an agricultural implement;

FIG. 2 is a perspective view of an embodiment of a container that may be used in the system of FIG. 1;

FIG. 3 is a schematic diagram of an embodiment of the system of FIG. 1;

FIG. 4 is a flow chart of an embodiment of a method for supplying a product to an agricultural implement using the system of FIG. 1; and

FIG. 5 is a perspective view of another embodiment of a product supply system having a delivery support vehicle.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

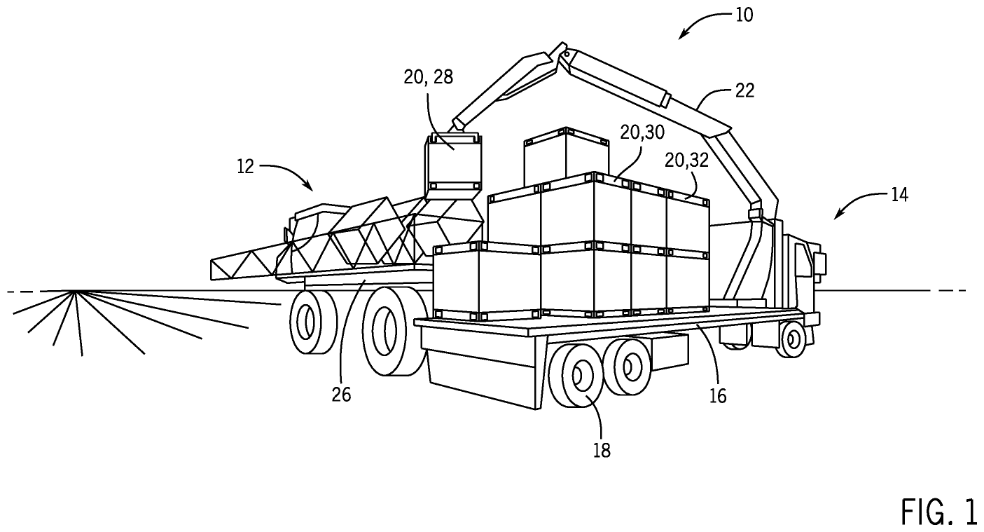

FIG. 1 is a perspective view of an embodiment of a product supply system 10 that may be used to supply a product (e.g., seed, fertilizer, fuel, or the like) to an agricultural implement 12 (e.g., a sprayer, a planter, a harvester, or the like). In the illustrated embodiment, the system 10 includes the agricultural implement 12 and a delivery vehicle 14 (e.g., truck). As shown, the delivery vehicle 14 includes a surface 16 (e.g., bed) that is supported by wheels 18 and that is configured to support one or more containers 20. The illustrated delivery vehicle 14 includes an arm 22 (e.g., crane, derrick, hoist, or the like) that is configured to engage the one or more containers 20 and to transfer the one or more containers 20 from the delivery vehicle 14 to the agricultural implement 12. The illustrated the delivery vehicle 14 also includes an operator cab 24 that enables an operator to control and to drive the delivery vehicle 14, although it should be understood that the delivery vehicle 14 may be a remotely operated vehicle or an autonomous vehicle.

The agricultural implement 12 is configured to receive (e.g., removably receive) one or more containers 20. For example, as shown, the agricultural implement 12 may include a surface 26 configured to support one or more containers 20. When the containers 20 are positioned on the surface 26, an outlet of the container 20 may align with an inlet of the agricultural implement 12 to enable the product to be used (e.g., directly from the container 20) by the agricultural implement 12 (e.g., applied to the field or used to fuel the agricultural implement 12 while the container 20 is mounted to the agricultural implement 12). In certain embodiments, the system 10 includes multiple agricultural implements 12 that are different from one another. For example, a first agricultural implement 12 may be a sprayer and a second agricultural implement 12 may be a planter. The system 10 may include any suitable number (e.g., 1, 2, 3, 4, 5, 10, 15, or more) of agricultural implements 12 of one or more types (e.g., sprayer, planter, harvester, etc.).

The delivery vehicle 14 may be configured to support any suitable number (e.g., 1, 2, 3, 4, 5, 10, 15, or more) of containers 20. Each of the containers 20 may house one or more products, and the multiple containers 20 may house different products. For example, a first container 20, 28 may house fertilizer (e.g., liquid or granular), a second container 20, 30 may house seed, and a third container 20, 32 may house fuel. As discussed in more detail below, the delivery vehicle 18 may include a controller that is configured to receive inputs and to provide outputs to facilitate transfer of an appropriate container 20 to the agricultural implement 12. For example, in some embodiments, the controller may receive an input indicative of a desired product for the agricultural vehicle 12, the controller may identify an appropriate container 20 that houses the desired product, and the controller may provide an indication of a location of the appropriate container 20 on a display and/or control the arm 22 to engage and to transfer the appropriate container 20 to the agricultural implement 12.

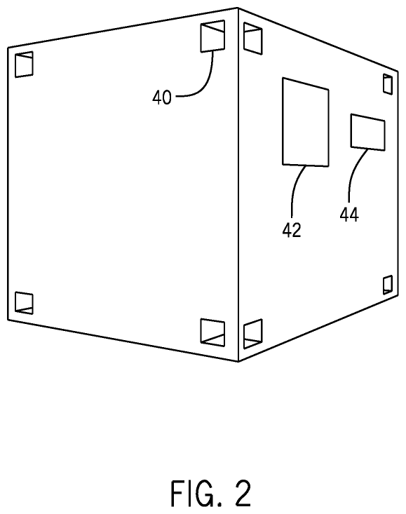

FIG. 2 is a perspective view of an embodiment of one container 20 that may be used in the system 10 of FIG. 1. In certain embodiments, the containers 20 of the system 10 may be standardized and/or identical to one another. For example, each container 20 in the system 10 may have the same shape and/or size to facilitate storage, stacking, transport, delivery, transfer to and use with the agricultural implements 12, or the like. In certain embodiments, each container 20 in the system 10 may include features to facilitate transfer of the container 20 to the agricultural implement 12. For example, the illustrated container 20 includes as recesses 40 (e.g., grooves) that enable the arm 22 of the delivery vehicle 14 to engage and to move the container 20. In some embodiments, the recesses 40 may facilitate coupling or mounting (e.g., removably mounting) the container 20 to the agricultural implement 12. For example, the recesses 40 may engage (e.g., snap into or fit within) corresponding components (e.g., protrusions on a frame or the surface 26) of the agricultural implement 12, thereby facilitating proper positioning of the containers 20 on the agricultural implement 12 (e.g., alignment of the outlets of the containers 20 with the inlets of the agricultural implement 12).

Each container 20 in the system 10 may include a display 42 (e.g., an electronic paper display or other bistable display) that is configured to display information about the container 20, such as a type of product within the container 20, compatible agricultural implement(s) 12, or the like. Additionally or alternatively, each container 20 may include an identification tag 44 (e.g., radio-frequency identification [RFID] tag) that is configured to provide the information about the container 20.

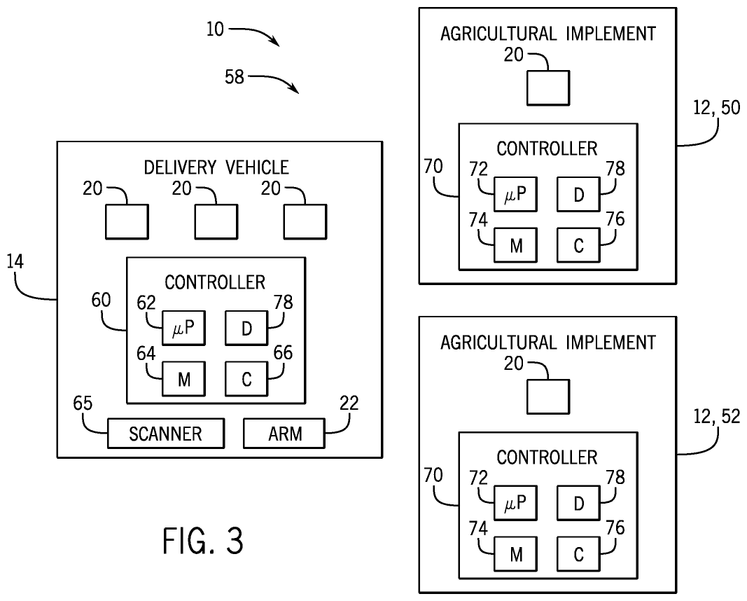

FIG. 3 is a schematic diagram of an embodiment of the system 10. As shown, the system 10 includes multiple agricultural implements 12 and the delivery vehicle 14. In particular, the illustrated system 10 includes a first agricultural implement 12, 50 and a second agricultural implement 12, 52. The first agricultural implement 12, 50 and the second agricultural implement 12, 52 may be different types of agricultural implements 12. For example, the first agricultural implement 12, 50 may be a sprayer, and the second agricultural implement 12, 52 may be a planter. As noted above, the system 10 may include any suitable number (e.g., 1, 2, 3, 4, 5, 10, 15, or more) of agricultural implements 12 of one or more types (e.g., sprayer, planter, harvester, etc.).

The first agricultural implement 12, 50 may be configured to use (e.g., apply to a field) a first product (e.g., fertilizer), and the second agricultural implement 12, 52 may be configured to use (e.g., apply to a field) a second product (e.g., seeds) that is different from the first product. The delivery vehicle 14 may support multiple containers 20 supporting multiple different types of product (e.g., fertilizer, seeds, fuel, etc.). Accordingly, in some embodiments, the system 10 may include a control system 58 to facilitate transfer of an appropriate container 20 (e.g., housing the appropriate or desired product) from the delivery vehicle 14 to each of the agricultural implements 12. Such a configuration may enable efficient supply (e.g., resupply) of various products to multiple agricultural implements 12 in a field.

With the foregoing in mind, in certain embodiments, the control system 58 may include one or more controllers (e.g., electronic controllers). For example, in certain embodiments, the delivery vehicle 14 may include a controller 60 having a processor 62 and a memory device 64. In certain embodiments, each of the agricultural implements 12 may include a controller 70 having a processor 72 and a memory device 74. In certain embodiments, the control system 58 may include communications devices 66, 76 (e.g., transceivers) that are configured to enable communication between the delivery vehicle 14 and the agricultural implements 12, for example. In certain embodiments, the control system 58 may include one or more displays 68, 78 that are configured to provide information for visualization by an operator.

In operation, the controller 60 associated with the delivery vehicle 14 may be configured to receive an input indicative of request to transfer a product (e.g., a desired or requested product) to one of the agricultural implements 12. In some embodiments, the input may be provided by an operator in the delivery vehicle 14 (e.g., via the display 68 or other user interface). In some embodiments, the input may be provided by an operator in the agricultural implement 12 (e.g., via the display 78 or other user interface) and transmitted (e.g., wirelessly) to the controller 60 of the delivery vehicle 14 via the communication devices 66, 76. The input may be provided in any suitable manner, such as via an operator input at a remote base station (e.g., remote from the system 10) or via an automated signal output from the controller 70 of the agricultural implement 12 in response to product depletion, for example.

The controller 60 may be configured to process the input and to identify and/or to locate an appropriate container 20 that houses the requested product. In some embodiments, the controller 60 may access data stored in the memory device 64 to facilitate locating the appropriate container 20. For example, as the containers 20 are loaded onto the delivery vehicle 14, information about each container 20 may be stored in the memory device 64 (e.g., manually by the operator or automatically via reading the display 42 or the identification tag 44). The data may include the product within the container 20, the exact (e.g., based on a relative coordinate system of the delivery vehicle 14) or approximate (e.g., based on general regions of the delivery vehicle 14, such as forward region, rearward region, top row, bottom row, etc.) location of the container 20 on the delivery vehicle 14, and/or characteristics of the container 20 (e.g., size, weight, or the like).

Additionally or alternatively, in some embodiments, the controller 60 may be configured to control a scanner 65 (e.g., reader, camera, or the like) to read the display 42 and/or the identification tag 44 on each container 20 supported on the delivery vehicle 14 until the appropriate container 20 is identified. In some embodiments, the scanner 65 may be supported on the arm 22, although in other embodiments, the scanner 65 may be supported on a separate movable component. In some embodiments, the scanner 65 may be used in conjunction with the data accessed from the memory device 64 to confirm the identification of the appropriate container 20.

In some embodiments, the controller 60 may be configured to provide the data accessed from the memory device 64 and/or the information obtained from the display 42 and/or the identification tag 44 on a display (e.g., the display 68 and/or the display 78), which may enable the operator to control (e.g., via inputs to the controller 70) the arm 22 to move toward, to engage, and/or to transfer the appropriate container 20 to the agricultural implement 12. In some embodiments, the controller 60 may be configured to, based on the data and/or the information, to automatically control the arm 22 to move toward, to engage, and/or to transfer the appropriate container 20 to the agricultural implement 12. In some embodiments, the controller 60 may be configured to access the data and to automatically control the arm 22 to move toward and/or to engage the appropriate container 20, and the operator may then manually control the arm 22 to transfer the engaged container 20 to the agricultural implement 20. It should be understood that the arm 22 may be controlled automatically (e.g., by the controller 60) and/or manually (e.g., via inputs by the operator) at any of the various stages of the process for identifying, locating, engaging, and/or transferring the appropriate container 20 to the agricultural implement 12.

In operation, the controller 60 may be configured to provide various indications related to the containers 20, the delivery vehicle 14, and/or the supply process to the operator (e.g., via the display 68 or the display 78). The various indications may include an indication of the products available in the containers 20 that are currently mounted on the delivery vehicle 14, a number of containers 20 housing each of the various types of products, a location of each container on the delivery vehicle 14 (e.g., via a table or a graph), a position of the arm 22 and/or the scanner 65, the information obtained from the display 42 or the RFID tag 44, the currently desired product (e.g., the input), or any combination thereof. The various indications may further include an indication that the appropriate container 20 has been identified, that the appropriate container 20 has been successfully engaged by the arm 22, that the appropriate container 20 has been successfully transferred to the agricultural implement 12, or any combination thereof.

In certain embodiments, the controller 60 is configured to track (e.g., with the scanner 65) and/or to store the information related to each of the containers 20 loaded onto the delivery vehicle 14 and/or the information related to each of the containers 20 removed from the delivery vehicle 14. Thus, the controller 60 may be configured to store and/or to update the data (e.g., in the memory device 64) related to the containers 20 that are currently on the delivery vehicle 14, movement of the containers 20, current locations of the containers 20 (e.g., on a particular agricultural implement 12), or the like. The controller 60 may also be configured to provide this information to the operator (e.g., via the display 68, 78). In some embodiments, the controller 60 may be configured to provide an indication (e.g., an alarm or an error message via the display 68, 78) based on the data. For example, the controller 60 may provide an indication in response to the input if none of the containers 20 on the delivery vehicle 14 house the desired product.

The controllers 60, 70 disclosed herein are electronic controllers having processors 62, 72 and memory devices 64, 74. The controllers 60, 70 may also include one or more storage devices and/or other suitable components. The processors 62, 72 may be used to execute software, such as software for operating the arm 22 to engage and/or to transfer the appropriate container 20 to the agricultural implement 12, operating the scanner 65 to read the display 42 and/or identification tag 44, providing indications, and so forth. Moreover, the processors 62, 72 may include multiple microprocessors, one or more “general-purpose” microprocessors, one or more special-purpose microprocessors, and/or one or more application specific integrated circuits (ASICS), or some combination thereof. For example, the processors 62, 72 may include one or more reduced instruction set (RISC) processors.

The memory devices 64, 74 may include a volatile memory, such as random access memory (RAM), and/or a nonvolatile memory, such as ROM. The memory devices 64, 74 may store a variety of information and may be used for various purposes. For example, the memory devices 64, 74 may store processor-executable instructions (e.g., firmware or software) for the processors 62, 72 to execute, such as instructions for operating the arm 22 to engage and/or to transfer the appropriate container 20 to the agricultural implement 12, operating the scanner 65 to read the display 42 and/or identification tag 44, providing indications, and so forth. The storage device(s) (e.g., nonvolatile storage) may include read-only memory (ROM), flash memory, a hard drive, or any other suitable optical, magnetic, or solid-state storage medium, or a combination thereof. The storage device(s) may store data (e.g., characteristics of the containers 20, respective locations of the containers 20 on the delivery vehicle 14, a number of containers 20 on the delivery vehicle 14, current availability of products on the delivery vehicle 14, etc.), instructions (e.g., software or firmware for operating the arm 22 to engage and/or to transfer the appropriate container 20 to the agricultural implement 12, operating the scanner 65 to read the display 42 and/or identification tag 44, providing indications, and so forth), and any other suitable data.

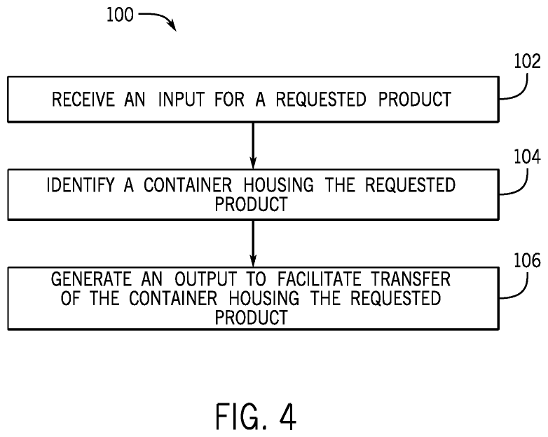

FIG. 4 is a flow chart of a method 100 for supplying a product to an agricultural implement 12, in accordance with an embodiment. The method 100 may be used to provide a plurality of products to one or more agricultural implements 12. The method 100 includes various steps represented by blocks. It should be noted that the method 100 may be performed as an automated procedure by a system, such as the control system 58. Although the flow chart illustrates the steps in a certain sequence, it should be understood that the steps may be performed in any suitable order, certain steps may be omitted, and certain steps may be carried out simultaneously, where appropriate. Further, certain steps or portions of the method 100 may be performed by separate devices. For example, a first portion of the method may be performed by the controller 60, while a second portion of the method may be performed by the controller 70.

In step 102, the controller 60 may receive an input indicative of a request to transfer a product to an agricultural implement 12. As discussed above, the input may be provided by an operator in the delivery vehicle 14 (e.g., via the display 68 or other user interface). In some embodiments, the input may be provided by an operator in the agricultural implement 12 (e.g., via the display 78 or other user interface) and transmitted (e.g., wirelessly) to the controller 60 of the delivery vehicle 14 via the communication devices 66, 76. The input may be provided in any suitable manner, such as via an operator input at a remote base station (e.g., remote from the system 10) or via an automated signal output from the controller 70 of the agricultural implement 12 in response to product depletion, for example.

In step 104, the controller 60 may identify the container 20 that houses the requested product. As discussed above, the controller 60 may access data stored in the memory device 64 to facilitate locating the appropriate container 20. Additionally or alternatively, in some embodiments, the controller 60 may be configured to control the scanner 65 to read the display 42 and/or the identification tag 44 on each container 20 supported on the delivery vehicle 14 until the appropriate container 20 is identified.

In step 106, the controller 60 may generate an output that facilitates transfer of the appropriate container 20 to the agricultural implement 12. In some embodiments, the controller 60 may be configured to cause display (e.g., on the display 68 and/or the display 78) of the data accessed from the memory device 64 and/or obtained via the scanner 65, which may enable the operator to control (e.g., via inputs to the controller 70) the arm 22 to move toward, to engage, and/or to transfer the appropriate container 20 to the agricultural implement 12. In some embodiments, the controller 60 may be configured to, based on the data and/or based on the data obtained via the scanner 65, to automatically control the arm 22 to move toward, to engage, and/or to transfer the appropriate container 20 to the agricultural implement 12.

It should be understood that, in some embodiments, the controller 60 may provide information and/or various indications related to the containers 20, the delivery vehicle 14, the agricultural implements 12, and/or the method 100 to the operator (e.g., via the display 68 or the display 78). The steps 102-16 may be repeated to provide another product (e.g., a different type of product) to another agricultural implement (e.g., a different type of agricultural implement 12).

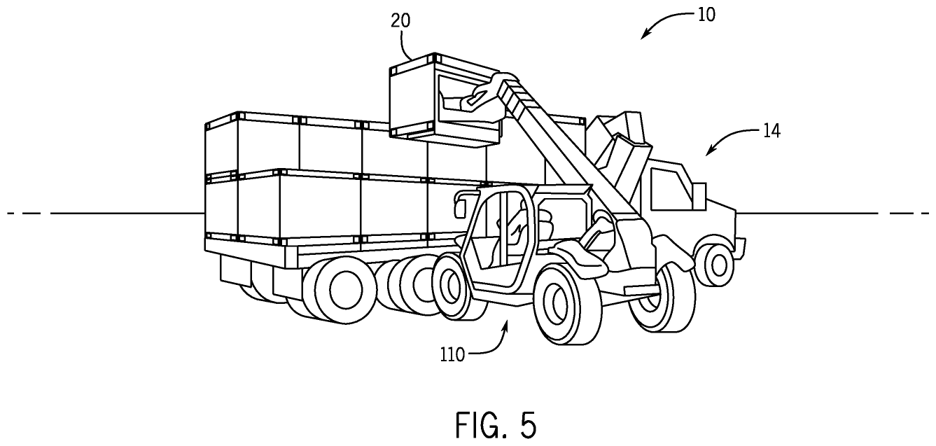

FIG. 5 is a perspective view of an embodiment of a delivery support vehicle 110 that may be used in the system 10 of FIG. 1. In addition to or as an alternative to the arm 22, the delivery support vehicle 110 may be used to engage an appropriate container 20 and to deliver the appropriate container 20 to the agricultural implement 12. The delivery support vehicle 110 may be controlled and driven by an operator, or the delivery support vehicle 110 may be a remotely operated vehicle or an autonomous vehicle. The delivery support vehicle 110 may include a controller in communication with the controllers 60, 70 and a display configured to provide any of a variety of the disclosed information and/or indications for visualization by the operator.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A product supply system, comprising:
a non-transitory computer-readable medium comprising instructions that when executed by a processor cause the processor to:
receive a first input indicative of a request to transfer a first product of the plurality of products to a first agricultural implement of the one or more of agricultural implements;
identify a first container of a plurality of containers that houses the first product; and
generate a first output that facilitates transfer of the first container to the first agricultural implement.

2. The product supply system of claim 1, wherein the first output comprises a displayed indication of a location of the first container, thereby facilitating transfer of the first container to the first agricultural implement by an operator.

3. The product supply system of claim 1, wherein the first output comprises a control signal that controls an arm to engage the first container to facilitate transfer of the first container to the first agricultural implement.

4. The product supply system of claim 1, wherein the non-transitory computer-readable medium comprises instructions that when executed by the processor cause the processor to provide a second output indicative of the plurality of products available for transfer to the one or more agricultural implements on a display.

5. The product supply system of claim 1, wherein the non-transitory computer-readable medium comprises instructions that when executed by the processor cause the processor to:
receive a second input requesting transfer of a second product of the plurality of products to a second agricultural implement of the plurality of agricultural implements, wherein the first agricultural implement and the second agricultural implements are different types of agricultural implements;
identify a second container of the plurality of containers that houses the second product; and
generate a second output that facilitates transfer of the second container to the second agricultural implement.

6. The product supply system of claim 1, comprising the plurality of containers, wherein the first container and the second container are standardized containers having the same size and shape.

7. The product supply system of claim 1, comprising a delivery vehicle configured to support the plurality of containers and to transport the plurality of containers.

8. The product supply system of claim 7, wherein the delivery vehicle comprises an arm, and the first output causes the arm to engage the first container and to move to transfer the first container to the first agricultural implement.

9. The product supply system of claim 7, wherein each of the plurality of containers comprises an electronic display or an identification tag, and the delivery vehicle includes a scanner that is configured to read the electronic display or the identification tag.

10. The product supply system of claim 7, wherein the non-transitory computer-readable medium comprises instructions that when executed by the processor cause the processor to locate the first container by accessing stored data indicative of a position of the first container on the delivery vehicle in a memory or by controlling a scanner to read respective electronic displays or identification tags of the plurality of containers.

11. A product supply system, comprising:
a plurality of containers configured to store a plurality of different products, wherein each of the plurality of containers is configured to be removably mounted to one or more agricultural implements to enable the one or more agricultural implements to use the plurality of products stored within the plurality of containers; and
a delivery vehicle configured to support the plurality of containers and to facilitate transfer of the plurality of containers to the one or more agricultural implements.

12. The product supply system of claim 11, wherein each of the plurality of containers comprises the same size and shape.

13. The product supply system of claim 11, wherein the delivery vehicle comprises a controller configured to:
receive an input indicative of a request to transfer a first product of the plurality of products to a first agricultural implement of the one or more agricultural implements; and
generate an output that facilitates transfer of a first container that houses the first product from the delivery vehicle to the first agricultural implement.

14. The product supply system of claim 11, wherein the delivery vehicle comprises an arm configured to engage the plurality of containers and to transfer an engaged container of the plurality of containers to the one or more agricultural implements.

15. A method of supplying a plurality of products to one or more agricultural implements, comprising:
receiving, at a controller, a first input indicative of a request to transfer a first product of the plurality of products to a first agricultural implement of the one or more of agricultural implements;
identifying, using the controller, a first container of a plurality of containers that houses the first product; and
generating, using the controller, a first output that facilitates transfer of the first container to the first agricultural implement.

16. The method of claim 15, wherein the first output comprises a displayed indication of a location of the first container, thereby facilitating transfer of the first container to the first agricultural implement by an operator.

17. The method of claim 15, wherein the first output comprises a control signal that controls an arm to engage the first container to facilitate transfer of the first container to the first agricultural implement.

18. The method of claim 15, comprising, using the controller, providing a second output indicative of the plurality of products available for transfer to the one or more agricultural implements on a display.

19. The method of claim 15, comprising receiving the first input from an operator or from a transmitter of the first agricultural implement.

20. The method of claim 15, comprising:
receiving, at the controller, a second input requesting transfer of a second product of the plurality of products to a second agricultural implement of the plurality of agricultural implements, wherein the first agricultural implement and the second agricultural implements are different types of agricultural implements;
identifying, using the controller, a second container of the plurality of containers that houses the second product; and
generating, using the controller, a second output that facilitates transfer of the second container to the second agricultural implement.
